(19) United States
(12) Patent Application Publication
(10) Pub. No.: US 2020/0208031 A1
(43) Pub. Date: Jul. 2, 2020

(54) Polyamide Resin Composition and Article Comprising the Same

(71) Applicant: Lotte Advanced Materials Co., Ltd., Yeosu-si (KR)

(72) Inventors: Sang Hwa LEE, Uiwang-si (KR); Ho Geun PARK, Uiwang-si (KR); Yeong Deuk SEO, Uiwang-si (KR); Sang Hyun HONG, Uiwang-si (KR)

(21) Appl. No.: 16/727,117

(22) Filed: Dec. 26, 2019

(30) Foreign Application Priority Data
Dec. 28, 2018 (KR) 10-2018-0173036

(51) Int. Cl. C09J 177/06; C08L 77/06

(52) U.S. Cl. CPC C09J 177/06; C08L 77/06; C08L 2203/20; C08L 2205/025; C08L 2205/03

(57) ABSTRACT

A polyamide resin composition includes: about 5% by weight (wt %) to about 50 wt % of an aromatic polyamide resin; about 10 wt % to about 60 wt % of an aliphatic polyamide resin; about 20 wt % to about 60 wt % of inorganic fillers; and about 0.5 wt % to about 5 wt % of a polyetheresteramide block copolymer, wherein the polyetheresteramide block copolymer is a polymer of a reaction mixture including about 5 wt % to about 95 wt % of an amino carboxylic acid, lactam or diamine-dicarboxylic acid salt and about 5 wt % to about 95 wt % of polyalkylene glycol. The polyamide resin composition can exhibit good adhesion with respect to other materials and anti-contamination (antifouling) properties.

### CROSS-REFERENCE TO RELATED APPLICATION

This application claims priority, under 35 USC Section 119, to and the benefit of Korean Patent Application No. 10-2018-0173036, filed on Dec. 28, 2018, the entire disclosure of which is incorporated herein by reference.

### FIELD

The present invention relates to a polyamide resin composition and an article comprising the same.

### BACKGROUND

Polyamide resins are used in various fields, such as interior/exterior materials of electric/electronic products and automotive components, due to good properties thereof in terms of heat resistance, abrasion resistance, chemical resistance, flame retardancy, and the like. For example, the polyamide resins are broadly used as exterior materials for portable devices, such as mobile phones, portable computers, and the like.

When used as exterior materials, polyamide resins can be easily stained or contaminated through contact with contaminants. Although various processes such as plating or coating are used to prevent contamination of polyamide resin products, the plating or coating process increases manufacturing costs and can cause various failures.

Moreover, there is a need for polyamide resin products exhibiting good adhesion with respect to other materials for various applications including exterior materials for portable devices.

Therefore, there is a need for a polyamide resin composition capable of suppressing contamination caused by various contaminants produced in daily life upon formation into products while easily securing adhesion with respect to other materials using a typical bonding agent.

### BRIEF DESCRIPTION OF DRAWINGS

FIG. 1 is a schematic sectional view of an electronic device housing according to one embodiment of the present disclosure.

### SUMMARY OF THE INVENTION

The present disclosure relates to a polyamide resin composition which can exhibit good adhesion with respect to other materials and can minimize or prevent contamination (can have anti-contamination or antifouling properties), and an article comprising the same.

The polyamide resin composition includes: about 5% by weight (wt %) to about 50 wt % of an aromatic polyamide resin; about 10 wt % to about 60 wt % of an aliphatic polyamide resin; about 20 wt % to about 60 wt % of inorganic fillers; and about 0.5 wt % to about 5 wt % of a polyetheresteramide block copolymer, wherein the polyetheresteramide block copolymer is a polymer of a reaction mixture including about 5 wt % to about 95 wt % of an amino carboxylic acid, lactam or diamine-dicarboxylic acid salt and about 5 wt % to about 95 wt % of polyalkylene glycol.

The aromatic polyamide resin can include a polymer of an aromatic dicarboxylic acid and an aliphatic diamine and/or a polymer of an aliphatic dicarboxylic acid and an aromatic diamine.

The aromatic polyamide resin may be a polymer of an aliphatic dicarboxylic acid and an aromatic diamine.

The aliphatic polyamide resin may include polyamide 6, polyamide 11, polyamide 12, polyamide 4,6, polyamide 6,6, polyamide 6,10, polyamide 6,12, polyamide 10,10, and/or polyamide 10,12.

The inorganic filler may include glass fiber, talc, wollastonite, whisker, silica, mica, and/or basalt fibers.

The polyetheresteramide block copolymer may have a weight average molecular weight of about 3,000 g/mol to about 70,000 g/mol, as measured by gel permeation chromatography (GPC).

A weight ratio of the aromatic polyamide resin to the aliphatic polyamide resin may range from about 1:0.1 to about 1:5.

A weight ratio of a polyamide resin including the aromatic polyamide resin and the aliphatic polyamide resin to the polyetheresteramide block copolymer may range from about 10:1 to about 70:1.

The polyamide resin composition may have an adhesive strength (shear strength) of about 850 kgf/cm² to 1,200 about kgf/cm², as measured in accordance with ASTM D1002 on an injection molded specimen having a size of 100 mm×25 mm×2 mm and bonded to a glass specimen having the same size as the injection molded specimen to overlap each other in an area of 30 mm×25 mm via a urethane-based bonding agent subjected to aging at 110° C., after heating a bonded portion between the specimens at 80° C. for 120 seconds and aging at room temperature for 5 minutes.

The polyamide resin composition may have an adhesive strength (shear strength) of about 950 kgf/cm² to about 1,300 kgf/cm², as measured in accordance with ASTM D1002 on an injection molded specimen having a size of 100 mm×25 mm×2 mm and bonded to a polycarbonate resin specimen having the same size as the injection molded specimen to overlap each other in an area of 30 mm×25 mm via a urethane-based bonding agent subjected to aging at 110° C., after heating a bonded portion between the specimens at 80° C. for 120 seconds and aging at room temperature for 5 minutes.

The polyamide resin composition may have a brightness recovery rate of about 90% or more, as calculated according to Equation 1:

Brightness recovery rate (%)=L₁/L₀×100 [Equation 1]

where L₀ is an initial L* value of an injection molded specimen having a size of 50 mm×90 mm×2 mm, as measured by a colorimeter, and L₁ is an L* value of the injection molded specimen, as measured by the colorimeter after drawing three lines on the specimen using a black permanent pen under a load of 200 g (distance between lines: 3 mm), maintaining the specimen under conditions of 50° C. and 95% RH (relative humidity) for 1 hour and then under conditions of 25° C. and 50% RH for 1 hour, followed by washing the surface of the specimen five times using ethanol and cloth.

The present disclosure also relates to an article. The article is formed of the polyamide resin composition as described herein.

The article may be a plastic member of an electronic device housing, wherein the electronic device housing includes a glass frame and the plastic member formed of the polyamide resin composition of the present disclosure, and wherein the plastic member formed of the polyamide resin composition of the present disclosure adjoins at least one surface of the glass frame.

The article may be a plastic member of an electronic device housing, wherein the electronic device housing includes a polycarbonate resin frame and the plastic member formed of the polyamide resin composition of the present disclosure, and wherein the plastic member formed of the polyamide resin composition of the present disclosure adjoins at least one surface of the polycarbonate resin frame.

### DETAILED DESCRIPTION

The above and other aspects, features, and advantages of the present invention will become apparent from the detailed description of the following embodiments. It should be understood that the present invention is not limited to the following embodiments and may be embodied in different ways by those skilled in the art without departing from the scope of the present invention. Rather, the embodiments are provided for complete disclosure and to provide thorough understanding of the present invention by those skilled in the art. The scope of the present invention should be defined only by the appended claims.

A polyamide resin composition according to the present disclosure includes: (A) an aromatic polyamide resin; (B) an aliphatic polyamide resin; (C) inorganic fillers; and (D) a polyetheresteramide block copolymer.

As used herein to represent a specific numerical range, the expression “a to b” means “≥a and ≤b”.

(A) Aromatic Polyamide Resin

The aromatic polyamide resin according to the present disclosure can serve to improve heat resistance, rigidity and/or impact resistance of the polyamide resin composition, and may be selected from any typical (conventional) aromatic polyamide resins known in the art for use in polyamide resin compositions.

The aromatic polyamide resin may include a polymer of an aromatic dicarboxylic acid and an aliphatic diamine; and/or a polymer of an aliphatic dicarboxylic acid and an aromatic diamine, as prepared by a polymerization method known in the art. For example, the polymer of the aliphatic dicarboxylic acid and the aromatic diamine may be used as the aromatic polyamide resin.

Herein, the “dicarboxylic acid” includes dicarboxylic acid, alkyl esters thereof (C₁ to C₄ lower alkyl esters, such as monomethyl, monoethyl, dimethyl, diethyl and/or dibutyl ester), and/or acid anhydrides thereof, and reacts with a diamine to form a repeat unit (dicarboxylic acid moiety) derived from the dicarboxylic acid. In addition, as used herein, the repeat unit derived from the dicarboxylic acid and a repeat unit (diamine moiety) derived from a diamine mean residues remaining after removal of a hydrogen atom (removed from an amine group), a hydroxyl group and/or an alkoxy group (removed from a carboxylic acid) in polymerization of the dicarboxylic acid and the diamine.

The aromatic dicarboxylic acid may include one or more C₈ to C₂₀ aromatic dicarboxylic acids. Examples of C₈ to C₂₀ aromatic dicarboxylic acids may include without limitation terephthalic acid, isophthalic acid, 2,6-naphthalenedicarboxylic acid, 2,7-naphthalenedicarboxylic acid, 1,4-naphthalenedicarboxylic acid, 1,4-phenylenedioxyphenylenic acid, 1,3-phenylenedioxydiacetic acid, diphenic acid, 4,4′-oxybis(benzoic acid), diphenylmethane-4,4′-dicarboxylic acid, diphenyl sulfone-4,4′-dicarboxylic acid, and/or 4,4′-diphenylcarboxylic acid, and the like, and combinations and/or mixtures thereof. For example, the aromatic dicarboxylic acid may be terephthalic acid, isophthalic acid, or a mixture thereof.

The aliphatic dicarboxylic acid may include one or more C₆ to C₂₀ linear, branched and/or cyclic aliphatic dicarboxylic acids. Examples of the aliphatic dicarboxylic acid may include without limitation adipic acid, sebacic acid, 1,4-cyclohexanedicarboxylic acid, and/or 1,3-cyclohexanedicarboxylic acid, and the like, and combinations and/or mixtures thereof. For example, the aliphatic dicarboxylic acid may be adipic acid and/or sebacic acid.

The aromatic diamine may include one or more C₆ to C₃₀ aromatic diamines. Examples of the aromatic diamine may include without limitation phenylene diamine compounds, such as m-phenylenediamine, p-phenylenediamine, and the like, xylene diamine compounds, such as m-xylenediamine, p-xylenediamine, and the like, naphthalene diamine compounds, and the like, and combinations and/or mixtures thereof.

The aliphatic diamine may include one or more C₄ to C₂₀ aliphatic diamines. Examples of the aliphatic diamine may include without limitation linear and/or branched aliphatic diamines including 1,4-butanediamine, 1,6-hexane diamine (hexamethylene diamine: HMDA), 1,7-heptanediamine, 1,8-octanediamine, 1,10-decanediamine (decanediamine: DDA), 1,12-dodecanediamine (dodecanediamine: DDDA), 3-methyl-1,5-pentanediamine, 2,2,4-trimethyl-1,6-hexanediamine, 2,4,4-trimethyl-1,6-hexanediamine, 5-methyl-1,9-nonanediamine, 2,2-oxybis(ethylamine), bis(3-aminopropyl)ether, ethylene glycol bis(3-aminopropyl)ether (EGBA), and/or 1,7-diamino-3,5-dioxyheptane, and the like, and combinations and/or mixtures thereof.

The aromatic polyamide resin may include repeat units A derived from the dicarboxylic acid and repeat units B derived from the diamine in a mole ratio (diamine B/dicarboxylic acid A) of about 0.95 to about 1.15, for example, about 1.00 to about 1.10. Within this range, a polyamide resin having a suitable degree of polymerization for formation can be prepared with minimal or no deterioration in properties due to unreacted monomers.

The aromatic polyamide resin may have a glass transition temperature of about 100° C. to about 150° C., for example, about 120° C. to about 140° C., as measured by differential scanning calorimetry (DSC). Within this range, the polyamide resin composition can have good properties in terms of heat resistance, rigidity, and/or impact resistance.

In addition, the aromatic polyamide resin may have an intrinsic viscosity [η] of about 0.7 dL/g to about 1.2 dL/g, for example, about 0.8 dL/g to about 1.0 dL/g, as measured using an Ubbelohde viscometer at 25° C. after dissolving the aromatic polyamide resin in a strong (98%) sulfuric acid solution to a concentration of 0.5 g/dL. Within this range, the polyamide resin composition can have good properties in terms of heat resistance, rigidity, and/or impact resistance.

The polyamide resin composition can include the aromatic polyamide resin in an amount of about 5 wt % to about 50 wt %, for example, about 10 wt % to about 40 wt %, based on the total weight (100 wt %) of the polyamide resin composition. In some embodiments, the polyamide resin composition can include the aromatic polyamide resin in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %, based on the total weight (100 wt %) of the polyamide resin composition. Further, according to some embodiments, the aromatic polyamide resin can be present in an amount of from about any of the foregoing amounts to about any other of the foregoing amounts.

If the content of the aromatic polyamide resin is less than about 5 wt %, the polyamide resin composition can suffer from deterioration in adhesion with respect to other materials (glass, polycarbonate, and the like), anti-contamination (antifouling) properties, external appearance, and/or mechanical properties, and if the content thereof exceeds about 50 wt %, the polyamide resin composition can suffer from deterioration in processability and the like.

(B) Aliphatic Polyamide Resin

The aliphatic polyamide resin according to the present disclosure can serve to improve impact resistance and/or processability of the polyamide resin composition together with the aromatic polyamide resin, and may be selected from any typical (conventional) aliphatic polyamide resins known in the art for use in polyamide resin compositions.

Examples of the aliphatic polyamide resin may include without limitation polyamide 6, polyamide 11, polyamide 12, polyamide 4,6, polyamide 6,6, polyamide 6,10, polyamide 6,12, polyamide 10,10, and/or polyamide 10,12, and the like, and combinations and/or mixtures thereof.

The aliphatic polyamide resin may have a relative viscosity [ηᵣₑₗ] of about 2 to about 3, for example, about 2.3 to about 2.8, as measured using an Ubbelohde viscometer at 25° C. after dissolving the aliphatic polyamide resin in a strong (96%) sulfuric acid solution to a concentration of 0.5 g/dL. Within this range, the polyamide resin composition can have good properties in terms of processability, impact resistance, and the like.

The polyamide resin composition can include the aliphatic polyamide resin in an amount of about 10 wt % to about 60 wt %, for example, about 20 wt % to about 50 wt %, based on the total weight (100 wt %) of the polyamide resin composition. In some embodiments, the polyamide resin composition can include the aliphatic polyamide resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %, based on the total weight (100 wt %) of the polyamide resin composition. Further, according to some embodiments, the aliphatic polyamide resin can be present in an amount of from about any of the foregoing amounts to about any other of the foregoing amounts.

If the content of the aliphatic polyamide resin is less than about 10 wt %, the polyamide resin composition can suffer from deterioration in processability, anti-contamination (antifouling) properties, and/or adhesion with respect to other materials, and if the content thereof exceeds about 60 wt %, the polyamide resin composition can suffer from deterioration in external appearance, anti-contamination (antifouling) properties, and the like.

The aromatic polyamide resin and the aliphatic polyamide resin may be present in a weight ratio of about 1:0.1 to about 1:5, for example, about 1:0.5 to about 1:4, and as another example about 1:0.3 to about 1:1. In some embodiments, the aromatic polyamide resin and the aliphatic polyamide resin may be present in a weight ratio of about 1:0.1, 1:0.2, 1:0.3, 1:0.4, 1:0.5, 1:0.6, 1:0.7, 1:0.8, 1:0.9, 1:1, 1:2, 1:3, 1:4, or 1:5. Further, according to some embodiments, the aromatic polyamide resin and the aliphatic polyamide resin may be present in a weight ratio of from about any of the foregoing ratios to about any other of the foregoing ratios.

Within this range, the polyamide resin composition can have good properties in terms of external appearance, anti-contamination (antifouling) properties, processability, and the like.

(C) Inorganic Filler

The inorganic fillers can serve to improve mechanical properties of the polyamide resin composition, such as rigidity and the like, and may be selected from typical (conventional) inorganic fillers known in the art for use in polyamide resin compositions.

Examples of the inorganic fillers may include without limitation glass fiber, talc, wollastonite, whisker, silica, mica, and/or basalt fibers, and the like, and combinations and/or mixtures thereof. For example, the inorganic fillers may be glass fibers.

The inorganic fillers may include glass fibers having a circular cross-section having an average diameter of about 5 μm to about 20 μm and a pre-processed length of about 2 mm to about 5 mm, and/or glass fibers having a flake and/or elliptical cross-sectional shape having an aspect ratio (long diameter/short diameter in cross-section) of about 1.5 to 10 and a pre-processed length of about 2 mm to about 5 mm, as measured using an optical microscope. Within this range, the polyamide resin composition can exhibit good properties in terms of mechanical properties and/or surface hardness with minimal or no deterioration in other properties including external appearance.

The glass fibers may have various shapes, such as fibrous, particulate, rod, needle, flake, and/or amorphous shapes, and may have various cross-sectional shapes, such as circular, elliptical, and/or rectangular cross-sectional shapes. For example, it is desirable in terms of mechanical properties that the glass fibers have circular and/or rectangular cross-sections.

The polyamide resin composition can include the inorganic fillers (for example glass fibers) in an amount of about 20 wt % to about 60 wt %, for example, about 30 to about 50 wt %, based on the total weight (100 wt %) of the polyamide resin composition. In some embodiments, the polyamide resin composition can include the inorganic fillers (for example glass fibers) in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %, based on the total weight (100 wt %) of the polyamide resin composition. Further, according to some embodiments, the inorganic fillers (for example glass fibers) can be present in an amount of from about any of the foregoing amounts to about any other of the foregoing amounts.

If the content of the inorganic filler is less than about 20 wt %, the polyamide resin composition can suffer from deterioration in rigidity, processability, and the like, and if the content thereof exceeds about 60 wt %, the polyamide resin composition can suffer from deterioration in external appearance, anti-contamination (antifouling) properties, and the like.

(D) Polyetheresteramide Block Copolymer

The polyetheresteramide block copolymer according to the present disclosure can serve to improve anti-contamination (antifouling) properties and/or adhesion of the polyamide resin composition with respect to other materials. The polyetheresteramide block copolymer may be a polymer (block copolymer) of a mixture including about 5 wt % to about 95 wt %, for example, about 35 wt % to about 65 wt %, of an amino carboxylic acid, lactam, and/or diamine-dicarboxylic acid salt, and about 5 wt % to about 95 wt %, for example, about 35 wt % to about 65 wt %, of polyalkylene glycol. Within these ranges, the polyamide resin can secure anti-contamination (antifouling) properties and/or adhesion with respect to other materials.

In some embodiments, the mixture of the amino carboxylic acid, lactam, and/or diamine-dicarboxylic acid salt and the polyalkylene glycol can include the amino carboxylic acid, lactam, and/or diamine-dicarboxylic acid salt in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %, based on the total weight (100 wt %) of the mixture of the amino carboxylic acid, lactam, and/or diamine-dicarboxylic acid salt and the polyalkylene glycol. Further, according to some embodiments, the amino carboxylic acid, lactam, and/or diamine-dicarboxylic acid salt can be present in an amount of from about any of the foregoing amounts to about any other of the foregoing amounts.

In some embodiments, the mixture of amino carboxylic acid, lactam, and/or diamine-dicarboxylic acid salt and the polyalkylene glycol can include the polyalkylene glycol in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %, based on the total weight (100 wt %) of the mixture of the amino carboxylic acid, lactam, and/or diamine-dicarboxylic acid salt and the polyalkylene glycol. Further, according to some embodiments, the polyalkylene glycol can be present in an amount of from about any of the foregoing amounts to about any other of the foregoing amounts.

Examples of the amino carboxylic acid, lactam and/or diamine-dicarboxylic acid salt may include without limitation C₆ to C₁₂ aminocarboxylic acids, such as ω-aminocaproic acid, ω-aminoenanthic acid, ω-aminocaprylic acid, ω-aminopelargonic acid, 1,1-aminoundecanoic acid, 1,2-aminododecanoic acid, and the like; C₆ to C₁₂ lactams, such as caprolactam, enantolactam, capryllactam, lauryllactam, and the like; and salts of C₆ to C₁₂ diamines and C₆ to C₁₂ dicarboxylic acids, such as salts of hexamethylenediamine-adipic acid, salts of hexamethylenediamine-isophthalic acid, and the like; and combinations and/or mixtures thereof. For example, 1,2-aminododecanoic acid, caprolactam, and/or salts of hexamethylenediamine-adipic acid may be used.

Examples of the polyalkylene glycol may include without limitation polyethylene glycol and/or polytetramethylene glycol, and the like, and combinations and/or mixtures thereof.

The polyalkylene glycol may have a weight average molecular weight (Mw) of about 10,000 g/mol to about 100,000 g/mol, as measured by gel permeation chromatography (GPC).

The polyetheresteramide block copolymer may further include about 70 parts by weight or less, for example, about 35 parts by weight to about 65 parts by weight, of a C₄ to C₂₀ dicarboxylic acid, relative to about 100 parts by weight of the mixture of the amino carboxylic acid, lactam, and/or diamine-dicarboxylic acid salt and the polyalkylene glycol. In some embodiments, the polyetheresteramide block copolymer can include the C₄ to C₂₀ dicarboxylic acid in an amount of about 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 parts by weight, based on about 100 parts by weight of the mixture of the amino carboxylic acid, lactam, and/or diamine-dicarboxylic acid salt and the polyalkylene glycol. Further, according to some embodiments, the C₄ to C₂₀ dicarboxylic acid can be present in an amount of from about any of the foregoing amounts to about any other of the foregoing amounts.

Within this range, the polyamide resin composition can secure good anti-contamination (antifouling) properties and/or adhesion with respect to other materials.

Examples of the C₄ to C₂₀ dicarboxylic acid may include without limitation terephthalic acid, 1,4-cyclohexacarboxylic acid, sebacic acid, adipic acid, and/or dodecane carboxylic acid, and the like, and combinations and/or mixtures thereof.

In some embodiments, a bond between the amino carboxylic acid, lactam and/or diamine-dicarboxylic acid salt and the polyalkylene glycol (polyethylene glycol and/or polytetramethylene glycol) may be an ester bond; a bond between the amino carboxylic acid, lactam and/or diamine-dicarboxylic acid salt and the C₄ to C₂₀ dicarboxylic acid may be an amide bond; and a bond between the polyalkylene glycol and the C₄ to C₂₀ dicarboxylic acid may be an ester bond.

The polyetheresteramide block copolymer may be prepared by well-known methods in the art, for example, by a method disclosed in JP Patent Publication No. S56-045419 or JP Unexamined Patent Publication No. S55-133424, the entire disclosure of each of which is incorporated by reference.

The polyetheresteramide block copolymer may have a weight average molecular weight of about 3,000 g/mol to about 70,000 g/mol, for example, about 20,000 g/mol to about 30,000 g/mol, as measured by GPC. Within this range, the polyamide resin composition can secure good anti-contamination (antifouling) properties and/or adhesion with respect to other materials.

The polyamide resin composition can include the polyetheresteramide block copolymer in an amount of about 0.5 wt % to about 5 wt %, for example, about 1 to about 4.5 wt %, based on the total weight (100 wt %) of the polyamide resin composition. In some embodiments, the polyamide resin composition can include the polyetheresteramide block copolymer in an amount of about 0.5, 0.6, 0.7, 0.8, 0.9, 1, 1.5, 2, 2.5, 3, 3.5, 4, 4.5, or 5 wt %, based on the total weight (100 wt %) of the polyamide resin composition. Further, according to some embodiments, the polyetheresteramide block copolymer can be present in an amount of from about any of the foregoing amounts to about any other of the foregoing amounts.

If the content of the polyetheresteramide block copolymer is less than about 0.5 wt %, the polyamide resin composition can suffer from deterioration in anti-contamination (antifouling) properties and/or adhesion with respect to other materials, and if the content thereof exceeds about 5 wt %, the polyamide resin composition can suffer from deterioration in external appearance and/or processability.

In some embodiments, a polyamide resin (A+B) (including the aromatic polyamide resin (A) and the aliphatic polyamide resin (B)) and the polyetheresteramide block copolymer (C) may be present in a weight ratio ((A+B):(C)) of about 10:1 to about 70:1, for example, about 12:1 to about 60:1, and as another example about 15:1 to about 35:1. Within this range, the polyamide resin composition can secure further improved properties in terms of adhesion with respect to other materials, anti-contamination (antifouling) properties, mechanical properties, external appearance, processability, and balance therebetween.

The polyamide resin composition may further optionally include typical additive(s), as needed, within a range not adversely affecting the effects of the present invention. Examples of the additives may include a heat stabilizer, a flame retardant, an antioxidant, a lubricant, a release agent, a nucleation agent, and/or a colorant, and the like, and mixtures thereof, without being limited thereto. The additives may be present in an amount of about 0.001 parts by weight to about 40 parts by weight, for example, about 0.1 parts by weight to about 20 parts by weight, relative to about 100 parts by weight of the polyamide resin (aromatic polyamide resin and aliphatic polyamide resin).

The polyamide resin composition may be prepared in pellet form by mixing the aforementioned components, followed by melt extrusion using a typical twin-screw extruder at about 270° C. to about 320° C., for example, about 280° C. to about 310° C.

The polyamide resin composition may have an adhesive strength (shear strength) of about 850 kgf/cm² to about 1,200 kgf/cm², for example, about 900 kgf/cm² to about 1,100 kgf/cm², as measured in accordance with ASTM D1002 on an injection molded specimen having a size of 100 mm×25 mm×2 mm and bonded to a glass specimen having the same size as the injection molded specimen to overlap each other in an area of 30 mm×25 mm via a urethane-based bonding agent subjected to aging at 110° C., after heating a bonded portion between the specimens at 80° C. for 120 seconds and aging at room temperature for 5 minutes.

The polyamide resin composition may have an adhesive strength (shear strength) of about 950 kgf/cm² to about 1,300 kgf/cm², for example, about 1,000 kgf/cm² to about 1,200 kgf/cm², as measured in accordance with ASTM D1002 on an injection molded specimen having a size of 100 mm×25 mm×2 mm and bonded to a polycarbonate resin specimen having the same size as the injection molded specimen to overlap each other in an area of 30 mm×25 mm via a urethane-based bonding agent subjected to aging at 110° C., after heating a bonded portion between the specimens at 80° C. for 120 seconds and aging at room temperature for 5 minutes.

The polyamide resin composition may have a brightness recovery rate of about 90% or more, for example, about 95% to about 99%, as calculated according to Equation 1:

Brightness recovery rate (%)=L₁/L₀×100 [Equation 1]

where L₀ is an initial L* (brightness) value of an injection molded specimen having a size of 50 mm×90 mm×2 mm, as measured by a colorimeter (MINOLTA, CM-3500d), and L₁ is an L* (brightness) value of the injection molded specimen, as measured by the colorimeter (MINOLTA, CM-3500d) after drawing three lines on the specimen using a black permanent pen (Monami, Namepen F) under a load of 200 g (distance between lines: 3 mm), maintaining the specimen under conditions of 50° C. and 95% RH (relative humidity) for 1 hour and then under conditions of 25° C. and 50% RH for 1 hour, followed by washing the surface of the specimen five times using ethanol and cloth.

An article according to the present disclosure is formed of the polyamide resin composition.

In some embodiments, the article may be a plastic member of an electronic device housing, wherein the electronic device housing includes a glass frame and the plastic member formed of the polyamide resin composition of the present disclosure, and wherein the plastic member formed of the polyamide resin composition of the present disclosure adjoins at least one surface of the glass frame.

In some embodiments, the article may be a plastic member of an electronic device housing, wherein the electronic device housing includes a polycarbonate resin frame and the plastic member formed of the polyamide resin composition of the present disclosure, and wherein the plastic member formed of the polyamide resin composition of the present disclosure adjoins at least one surface of the polycarbonate resin frame.

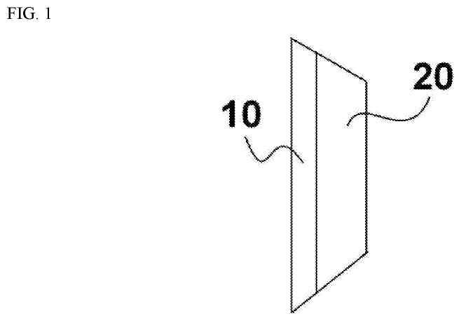

FIG. 1 is a schematic sectional view of an electronic device housing according to one embodiment of the present disclosure. It should be understood that thicknesses and/or widths of components in the drawing are exaggerated for convenience and the present invention is not limited thereto. Referring to FIG. 1, the electronic device housing according to the embodiment includes a glass or polycarbonate resin frame 10; and a plastic member 20 adjoining at least one surface of the glass or polycarbonate resin frame 10, wherein the plastic member is formed of the polyamide resin composition according to the present disclosure. The glass or polycarbonate resin frame 10 and the plastic member 20 may have various shapes instead of being limited to particular shapes. The plastic member 20 adjoins at least one surface of the glass or polycarbonate resin frame 10. The adjoining structure may be realized by bonding or insertion and is not limited to a particular method.

The glass or polycarbonate resin frame 10 may be selected from commercially available products applicable to typical electronic device housings.

The plastic member 20 may be formed from the polyamide resin composition through various molding methods, such as injection molding, extrusion molding, casting, and the like.

The plastic member 20 may be an interior material of an electric and/or electronic device.

Next, the present invention will be described in more detail with reference to the following examples. It should be understood that these examples are provided for illustration only and are not to be in any way construed as limiting the present invention.

### EXAMPLE

Details of components used in the following Examples and Comparative Examples are as follows.

(A) Aromatic Polyamide Resin

Polyamide MXD10 (Manufacturer: Arkema, Product Name: RILSAN XIVIFO, intrinsic viscosity [η]: 0.75 dL/g)

(B) Aliphatic Polyamide Resin

Polyamide 12 (Manufacturer: Evonik, Product Name: VESTAMID L)

(C) Inorganic Filler

Glass fiber (Manufacturer: NITTOBO, Product Name: 3PA-820)

(D) Polyetheresteramide Block Copolymer

(D1) A polymer of a reaction mixture comprising 51 wt % of C₁₂ amino carboxylic acid and 49 wt % of polyethylene glycol (weight average molecular weight: 32,000 g/mol)

(D2) A polymer of a reaction mixture comprising 96 wt % of C₁₂ amino carboxylic acid and 4 wt % of polyethylene glycol (weight average molecular weight: 33,000 g/mol)

(D3) A polymer of a reaction mixture comprising 97 wt % of C₁₂ amino carboxylic acid and 3 wt % of polytetramethylene glycol (weight average molecular weight: 25,000 g/mol)

### Examples 1 to 8 and Comparative Examples 1 to 8

The aforementioned components are mixed in amounts as listed in Tables 1 and 2. Then, the mixture is subjected to melt-extrusion in a twin-screw extruder (L/D: 40, Φ: 45 mm) at a barrel temperature of 300° C., thereby preparing a polyamide resin composition in pellet form. The prepared pellets are dried at 100° C. for 6 to 8 hours and subjected to injection molding using an injection machine under conditions of a cylinder temperature of 320° C. and a mold temperature of 80° C., thereby preparing a specimen. The prepared specimen is evaluated as to the following properties. Results are shown in Tables 1 and 2.

Property Evaluation

(1) Adhesive strength (shear strength), unit: kgf/cm²): Adhesive strength is measured in accordance with ASTM D1002 on an injection molded specimen having a size of 100 mm×25 mm×2 mm and bonded to a glass specimen or a polycarbonate (PC) resin specimen having the same size as the injection molded specimen to overlap each other in an area of 30 mm×25 mm via a urethane-based bonding agent subjected to aging at 110° C. after heating a bonded portion between the specimens at 80° C. for 120 seconds and aging at room temperature for 5 minutes.

(2) Brightness recovery rate (unit: %): Brightness recovery rate is calculated according to Equation 1:

Brightness recovery rate (%)=L₁/L₀×100 [Equation 1]

where L₀ is an initial L* (brightness) value of an injection molded specimen having a size of 50 mm×90 mm×2 mm, as measured by a colorimeter (MINOLTA, CM-3500d), and L₁ is an L* (brightness) value of the injection molded specimen, as measured by the colorimeter (MINOLTA, CM-3500d) after drawing three lines on the specimen using a black permanent pen (Monami, Namepen F) under a load of 200 g (distance between lines: 3 mm), maintaining the specimen under condition of 50° C. and 95% RH (relative humidity) for 1 hour and then under conditions of 25° C. and 50% RH for 1 hour, followed by washing the surface of the specimen five times using ethanol and cloth.

(3) Notched Izod impact strength (unit: kgf·cm/cm): Notched Izod impact strength is measured on a ⅛″ thick Izod specimen in accordance with ASTM D256.

(4) Flexural modulus (unit: kgf/cm²): Flexural modulus is measured on a 6.4 mm specimen at a rate of 2.8 mm/min in accordance with ASTM D790.

TABLE 1

| | | Example | | | | | | | |
|---|---|---|---|---|---|---|---|---|---|
| | | 1 | 2 | 3 | 4 | 5 | 6 | 7 | 8 |
| (A) (wt %) | | 20 | 15 | 30 | 40 | 20 | 30 | 30 | 40 |
| (B) (wt %) | | 45 | 50 | 30 | 20 | 40 | 30 | 30 | 10 |
| (C) (wt %) | | 33 | 33 | 37 | 39 | 36 | 39 | 36 | 46 |
| (D1) (wt %) | | 2 | 2 | 3 | 1 | 4 | 1 | 4 | 5 |
| (D2) (wt %) | | — | — | — | — | — | — | — | — |
| (D3) (wt %) | | — | — | — | — | — | — | — | — |
| Adhesive | Glass | 900 | 950 | 1000 | 980 | 1050 | 970 | 1080 | 1090 |
| strength | PC | 1020 | 1050 | 1100 | 1050 | 1100 | 1070 | 1100 | 1180 |

| | | | | | | | | |
|---|---|---|---|---|---|---|---|---|
| Brightness | 96 | 97 | 96 | 97 | 96 | 96 | 97 | 94 |
| recovery rate | | | | | | | | |
| Notched Izod | 14 | 15 | 15 | 15 | 14 | 15 | 15 | 16 |
| impact strength | | | | | | | | |
| Flexural modulus | 85,000 | 85,000 | 95,000 | 100,000 | 97,000 | 107,000 | 96,000 | 120,000 |

TABLE 2

| | | Comparative Example | | | | | | | |
|---|---|---|---|---|---|---|---|---|---|
| | | 1 | 2 | 3 | 4 | 5 | 6 | 7 | 8 |
| (A) (wt %) | | — | 1 | 60 | 55 | 30 | 30 | 30 | 30 |
| (B) (wt %) | | 60 | 59 | — | 5 | 30 | 30 | 30 | 30 |
| (C) (wt %) | | 37 | 37 | 37 | 37 | 39.9 | 34 | 37 | 37 |
| (D1) (wt %) | | 3 | 3 | 3 | 3 | 0.1 | 6 | — | — |
| (D2) (wt %) | | — | — | — | — | — | — | 3 | — |
| (D3) (wt %) | | — | — | — | — | — | — | — | 3 |
| Adhesive | Glass | 450 | 440 | 500 | 920 | 310 | 970 | 290 | 210 |
| strength | PC | 520 | 630 | 580 | 990 | 550 | 1010 | 400 | 300 |

| | | | | | | | | |
|---|---|---|---|---|---|---|---|---|
| Brightness | 71 | 73 | 65 | 72 | 91 | 83 | 94 | 93 |
| recovery rate | | | | | | | | |
| Notched Izod | 14 | 13 | 9 | 11 | 13 | 14 | 13 | 14 |
| impact strength | | | | | | | | |
| Flexural modulus | 96,000 | 95,000 | 99,000 | 98,000 | 100,000 | 88,000 | 96,000 | 96,500 |

From the results, it can be seen that the polyamide resin compositions (Examples 1 to 8) according to the present disclosure exhibit good properties in terms of adhesion with respect to other materials (adhesive strength between glass and polycarbonate, or PC), anti-contamination (antifouling) properties (brightness recovery rate), impact resistance (notched Izod impact strength), and rigidity (flexural modulus).

Conversely, it can be seen that the resin composition of Comparative Example 1 prepared without the aromatic polyamide resin suffers from deterioration in adhesion with respect to other materials and anti-contamination (antifouling) properties; the resin composition of Comparative Example 2 prepared using a small amount of the aromatic polyamide resin suffers from deterioration in adhesion with respect to other materials and anti-contamination (antifouling) properties; the resin composition of Comparative Example 3 prepared without the aliphatic polyamide resin suffers from deterioration in adhesion with respect to other materials, anti-contamination (antifouling) properties, and impact resistance; and the resin composition of Comparative Example 4 prepared using a small amount of aliphatic polyamide resin and an excess of the aromatic polyamide resin suffers from deterioration in anti-contamination (antifouling) properties. In addition, it can be seen that the resin composition of Comparative Example 5 prepared using a small amount of the polyetheresteramide block copolymer suffers from deterioration in adhesion with respect to other materials; the resin composition of Comparative Example 6 prepared using an excess of the polyetheresteramide block copolymer suffers from deterioration in anti-contamination (antifouling) properties; the resin composition of Comparative Example 7 prepared using the polyetheresteramide block copolymer (D2) instead of the polyetheresteramide block copolymer (D1) according to the present disclosure suffers from deterioration in adhesion with respect to other materials; and the resin composition of Comparative Example 8 prepared using the polyetheresteramide block copolymer (D3) suffers from deterioration in adhesion with respect to other materials.

It is within the scope of this disclosure for one or more of the terms “substantially,” “about,” “approximately,” and/or the like, to qualify each adjective and adverbs of the foregoing disclosure, to provide a broad disclosure. As an example, it is believed those of ordinary skill in the art will readily understand that, in different implementations of the features of this disclosure, reasonably different engineering tolerances, precision, and/or accuracy may be applicable and suitable for obtaining the desired result. Accordingly, it is believed those of ordinary skill will readily understand usage herein of the terms such as “substantially,” “about,” “approximately,” and the like.

The use of the term “and/or” includes any and all combinations of one or more of the associated listed items.

Exemplary embodiments have been disclosed herein, and although specific terms are employed, unless otherwise noted, they are to be interpreted in a generic and descriptive sense only and not for purpose of limitation. Also although some embodiments have been described above, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

What is claimed is:

1. A polyamide resin composition comprising:
about 5 wt % to about 50 wt % of an aromatic polyamide resin;
about 10 wt % to about 60 wt % of an aliphatic polyamide resin;
about 20 wt % to about 60 wt % of inorganic fillers; and
about 0.5 wt % to about 5 wt % of a polyetheresteramide block copolymer,
wherein the polyetheresteramide block copolymer is a polymer of a reaction mixture comprising about 5 wt % to about 95 wt % of an amino carboxylic acid, lactam and/or diamine-dicarboxylic acid salt and about 5 wt % to about 95 wt % of polyalkylene glycol.

2. The polyamide resin composition according to claim 1, wherein the aromatic polyamide resin comprises a polymer of an aromatic dicarboxylic acid and an aliphatic diamine and/or a polymer of an aliphatic dicarboxylic acid and an aromatic diamine.

3. The polyamide resin composition according to claim 1, wherein the aromatic polyamide resin is a polymer of an aliphatic dicarboxylic acid and an aromatic diamine.

4. The polyamide resin composition according to claim 1, wherein the aliphatic polyamide resin comprises polyamide 6, polyamide 11, polyamide 12, polyamide 4,6, polyamide 6,6, polyamide 6,10, polyamide 6,12, polyamide 10,10, and/or polyamide 10,12.

5. The polyamide resin composition according to claim 1, wherein the inorganic filler comprises glass fiber, talc, wollastonite, whisker, silica, mica, and/or basalt fibers.

6. The polyamide resin composition according to claim 1, wherein the polyetheresteramide block copolymer has a weight average molecular weight of about 3,000 g/mol to about 70,000 g/mol, as measured by gel permeation chromatography (GPC).

7. The polyamide resin composition according to claim 1, wherein a weight ratio of the aromatic polyamide resin to the aliphatic polyamide resin ranges from about 1:0.1 to about 1:5.

8. The polyamide resin composition according to claim 1, wherein a weight ratio of a polyamide resin comprising the aromatic polyamide resin and the aliphatic polyamide resin to the polyetheresteramide block copolymer ranges from about 10:1 to about 70:1.

9. The polyamide resin composition according to claim 1, wherein the polyamide resin composition has an adhesive strength (shear strength) of about 850 kgf/cm² to 1,200 about kgf/cm², as measured in accordance with ASTM D1002 on an injection molded specimen having a size of 100 mm×25 mm×2 mm and bonded to a glass specimen having the same size as the injection molded specimen to overlap each other in an area of 30 mm×25 mm via a urethane-based bonding agent subjected to aging at 110° C., after heating a bonded portion between the specimens at 80° C. for 120 seconds and aging at room temperature for 5 minutes.

10. The polyamide resin composition according to claim 1, wherein the polyamide resin composition has an adhesive strength (shear strength) of about 950 kgf/cm² to about 1,300 kgf/cm², as measured in accordance with ASTM D1002 on an injection molded specimen having a size of 100 mm×25 mm×2 mm and bonded to a polycarbonate resin specimen having the same size as the injection molded specimen to overlap each other in an area of 30 mm×25 mm via a urethane-based bonding agent subjected to aging at 110° C., after heating a bonded portion between the specimens at 80° C. for 120 seconds and aging at room temperature for 5 minutes.

11. The polyamide resin composition according to claim 1, wherein the polyamide resin composition has a brightness recovery rate of about 90% or more, as calculated according to Equation 1:
Brightness recovery rate (%)=L₁/L₀×100 [Equation 1]
where L₀ is an initial L* value of an injection molded specimen having a size of 50 mm×90 mm×2 mm, as measured by a colorimeter, and L₁ is an L* value of the injection molded specimen, as measured by the colorimeter after drawing three lines on the specimen using a black permanent pen under a load of 200 g (distance between lines: 3 mm), maintaining the specimen under condition of 50° C. and 95% RH (relative humidity) for 1 hour and then under conditions of 25° C. and 50% RH for 1 hour, followed by washing the surface of the specimen five times using ethanol and cloth.

12. An article formed of the polyamide resin composition according to claim 1.

13. The article according to claim 12, wherein the article is a plastic member of an electronic device housing, wherein the electronic device housing comprises a glass frame and the plastic member, and wherein the plastic member adjoins at least one surface of the glass frame.

14. The article according to claim 12, wherein the article is a plastic member of an electronic device housing, wherein the electronic device housing comprises a polycarbonate resin frame and the plastic member, and wherein the plastic member adjoins at least one surface of the polycarbonate resin frame.
